(19) United States
(12) Patent Application Publication
(10) Pub. No.: US 2024/0099524 A1
(43) Pub. Date: Mar. 28, 2024

(54) CLEANING TOOL FOR TOILET BOWL

(71) Applicant: JOYU PULP Co.,Ltd., Shikokuchuo-shi (JP)

(72) Inventors: Tatsuya IKAWA, Shikokuchuo-shi (JP); Shizuna TAKAHASHI, Shikokuchuo-shi (JP)

(21) Appl. No.: 18/530,455

(22) Filed: Dec. 6, 2023

Related U.S. Application Data
(63) Continuation of application No. PCT/JP2021/039968, filed on Oct. 29, 2021.

(30) Foreign Application Priority Data
Jun. 15, 2021 (JP) 2021-099109
Aug. 6, 2021 (JP) 2021-129426

(51) Int. Cl. A47K 11/10

(52) U.S. Cl. CPC A47K 11/10; B08B 1/165; B08B 1/30

(57) ABSTRACT

A toilet bowl cleaning tool formed from a single sheet (rectangular and water soluble) for removing a stain from a toilet bowl. The sheet has first fold lines that are fold lines parallel to one of sides of the sheet and that divide the sheet at equal intervals, first fold pieces segmented by the first fold lines, and a second fold line used as a reference for folding the sheet into an approximately L-shape in a cross-section of the tool. After the sheet is folded based on the plurality of the first fold lines so that the first fold pieces are stacked to form an approximately rectangular shape whose longer sides are parallel to the first fold lines, the second fold line is provided to be parallel to the longer sides of the rectangular shape and to divide the shorter sides into an approximately half.

### CROSS REFERENCE TO RELATED APPLICATIONS

This application is a continuation of International Application No.: PCT/JP2021/39968, which was filed on Oct. 29, 2021, is based on and claims priority to Japanese Patent Applications No. 2021-99109 filed on Jun. 15, 2021, and claims priority to Japanese Patent Applications No. 2021-129426 filed on Aug. 6, 2021, which is herein incorporated by reference.

### TECHNICAL FIELD

This invention relates to a toilet bowl cleaning tool for removing stains (or waste, filth, excrement etc.) adhering to an inside of a toilet bowl.

### BACKGROUND

Flushable toilet bowls has a function to flush water after use, and to wash the stains away for hygienic disposal using the force of the water. However, as toilet bowls deteriorate over time, they become prone to fouling. Therefore, even if the water is flushed out after use, the stains frequently remain adhering to the toilet bowl. In such cases, conventionally, a so-called toilet brush is used to remove the stains by scrubbing the stained areas of the toilet bowl. The toilet brush is a cleaning tool designed for cleaning a toilet bowl, consisting of a handgrip for the user to hold and a brush body provided at the end of the handle. The brush body is made of synthetic resin such as nylon. However, since the toilet brush is used repeatedly, there was an issue that the toilet brush and a case/container to store the brush become unsanitary.

For such an issue, for example, Patent Literature 1 discloses technology for a toilet bowl cleaning tool comprising a handgrip (handle) for the user to hold and a brush body (brush head) that is detachably attached to the end of the handle. According to this technology, the brush body is made of water soluble material and can be discarded in the toilet bowl after use and flushed with water for disposal. The cleaning tool is more sanitary than conventional toilet brushes.

### RELATED ART

### Patent Literature(s)

[Patent Doc. 1] Patent Laid-Open Publication 2007-530081

### SUBJECT TO BE SOLVED

However, even in the toilet bowl cleaning tool disclosed in Patent Document 1, the handle is used repeatedly. Unlike the brush body, the handle does not get dirty by direct contact with the toilet bowl. However, it may get dirty indirectly, for example, during cleaning, as water droplets or stored water in the toilet bowl splash and adhere to it. Therefore, the handle itself is not completely hygienically clean.

The present invention was made in view of these conventional circumstances. One of the objects of the present invention is to provide a toilet bowl cleaning tool that is strong enough to remove stains adhering to the inside of the toilet bowl and that is entirely disposable.

### SUMMARY

In the toilet bowl cleaning tool according to the first aspect of the present invention formed from a single sheet, which is rectangular and water soluble, for removing a stain from an inside of a toilet bowl, the sheet has a plurality of first fold lines that are fold lines parallel to one of sides of the sheet and that divide the sheet at equal intervals, a plurality of first fold pieces that are pieces segmented by the first fold lines, and a second fold line that is a folding line used as a reference for folding the sheet into an approximately L-shape in a cross-section of the toilet bowl cleaning tool, wherein, after the sheet is folded based on the plurality of the first fold lines so that the first fold pieces are stacked to form an approximately rectangular shape whose longer sides are parallel to the first fold lines, the second fold line is provided to be parallel to the longer sides of the rectangular shape and to divide the shorter sides into an approximately half.

In the toilet bowl cleaning tool according to the second aspect of the present invention, a product of a basis weight of the sheet and the number of first fold pieces is ranged from 200 to 500 g/m².

Further, in the toilet bowl cleaning tool according to the third aspect of the present invention, the first fold lines are used as a reference for folding the sheet in an order from one of the first fold lines that is positioned close to one of the vertical sides, which is parallel to the one of the first fold lines.

With the above configuration, the tool can be realized to be strong enough to remove a stain adhering to the inside of the toilet bowl. Since the sheet is made of water soluble paper, the toilet bowl cleaning tool can be disposed after use by discarding it in the toilet bowl and flushing it with water (disposable), making it hygienic. Further, because it can be manufactured by folding a piece of sheet, it can be easily and inexpensively manufactured.

Further, in the toilet bowl cleaning tool according to the fourth aspect of the present invention, the sheet has a number of the first fold pieces that is two to the power of four or more, the sheet is folded based on one of the first fold lines, which is positioned at a center of the sheet among the first fold lines, and is defined as a center fold line. Under a state where the sheet has been folded one or more times based on the first fold lines, the sheet is manufactured by being further folded based on the center fold line. According to the above configuration, for example, when manufacturing a toilet bowl cleaning tool with eight first fold pieces, the sheet is to be folded only three times (when folding at each first fold line, the sheet needs to be folded seven times), thus increasing the manufacturing speed.

Further, in the toilet bowl cleaning tool according to the fifth aspect of the present invention, the sheet has a number of the first fold pieces that is an even number except for two to the power of any integer, the sheet is folded based on one of the first fold lines, which is positioned at a center of the sheet among the first fold lines, and is defined as a center fold line, under a state where the sheet has been folded one or more times based on the first fold lines, the sheet is further folded based on the center fold line, and the first fold lines are used as a reference for folding the sheet in an order from one of the first fold lines that is positioned close to one of the sides of the sheet, which is parallel to the first fold lines. According to the above configuration, for example, when manufacturing a toilet bowl cleaning tool with twelve first fold pieces, the sheet is to be folded only four times (when folding at each first fold line, the sheet needs to be folded eleven times), thus increasing the manufacturing speed.

Further, in the toilet bowl cleaning tool according to the sixth aspect of the present invention, the sheet has a number of the first fold pieces that is a multiple of three, the sheet is manufactured by folding the sheet based on two of the first fold lines that are arranged at positions to divide the sheet into three equal parts, and under a sheet that has been folded multiple times based on the two of the first fold lines, by being folded based on another of the first fold lines. According to the above configuration, for example, when manufacturing a toilet bowl cleaning tool with six first fold pieces, the sheet is to be folded by folding into three pieces using a folding board, next folding into half so that the toilet bowl cleaning tool is manufactured. It makes a design of the manufacturing equipment for the tool easy, and reducing a cost of the manufacturing equipment.

### BRIEF DESCRIPTION OF THE DRAWINGS

FIG. 1 is a schematic diagram of a toilet bowl cleaning tool to which the present invention is applied.

FIG. 2 is an explanatory diagram of the use method of the toilet bowl cleaning tool to which the present invention is applied.

FIG. 3 is an explanatory diagram of the use method of a toilet bowl cleaning tool to which the present invention is applied.

FIG. 4 is a schematic diagram of the sheet, which is the material used for the toilet bowl cleaning tools.

FIG. 5 is an explanatory diagram of how to fold the sheet.

FIG. 6 is an explanatory diagram of how to fold the sheet.

FIG. 7 is an explanatory diagram of how to fold the sheet.

FIG. 8 is a schematic diagram of the experimental apparatus used for testing the strength of toilet bowl cleaning tools.

FIG. 9 shows a graph summarizing the experimental results of the strength of toilet bowl cleaning tools.

FIG. 10 is a graph summarizing the results of experiments of the water solubility of toilet bowl cleaning tools.

FIG. 11 is an explanatory diagram of how to fold the sheet

### PREFERRED EMBODIMENT(S) OF THE PRESENT INVENTION

The following is a description of the embodiments of the present invention based on the drawings. However, the embodiments shown below are examples to embody the technical concept of the present invention, and the invention should not be specified by them as follows. In addition, this specification in no way identifies the components (or elements) indicated in the claims to the components of the embodiments. In particular, the dimensions, materials, shapes, and relative arrangement of the components described in the embodiments are not intended to limit the scope of the present invention to them, unless otherwise specifically stated. The embodiments are merely illustrative examples of the present invention. The size and positional relationship of the parts and materials shown in the drawings may be exaggerated for the sake of clarity of explanation. Furthermore, in the following explanations, the same names and symbols indicate the same or similar components, and detailed explanations are omitted as appropriate. Furthermore, each element constituting the present invention may be realized in a manner in which a plurality of elements are composed of the same member and a single member serves as a plurality of elements, or conversely, the function of a single member may be shared by a plurality of members.

### [Toilet Bowl Cleaning Tool 1]

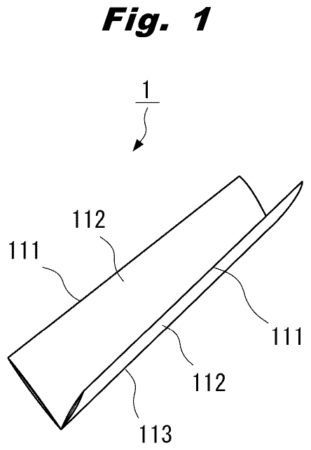

Toilet bowl cleaning tool 1 in accordance with one embodiment of the present invention will be described based on FIGS. 1 through 10.

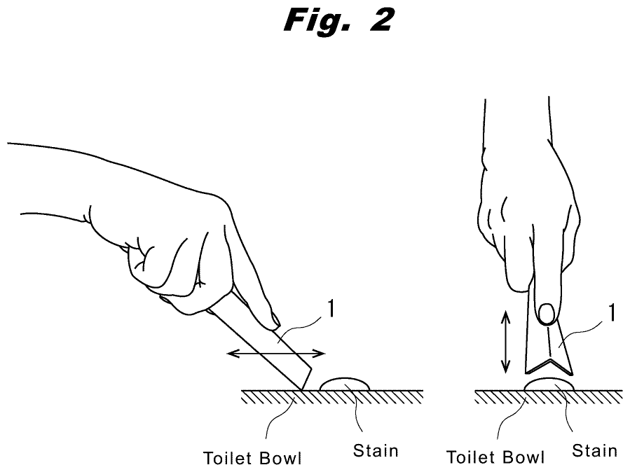

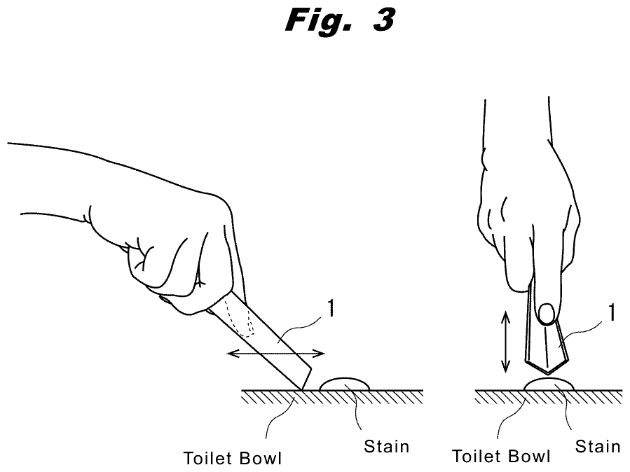

As shown in FIG. 1, toilet bowl cleaning tool 1 is a cleaning tool shaped like a rectangular board member that is folded into an abbreviated L-shape in cross section, and the tool is formed by folding a piece of sheet 11. As shown in FIGS. 2 and 3, the user, for example, grasps toilet bowl cleaning tool 1 and scrubs an area on the toilet bowl where the stain is attached so that the stain is removed.

### <Sheet 11>

In the application, sheet 11 means paper in a rectangular shape of, for example, about 125 mm on one opposite side and about 128 mm on the other opposite side, which is a material of toilet bowl cleaning tool 1. Since sheet 11 is made of water soluble paper, toilet bowl cleaning tool 1 can be disposed after use by discarding it in the toilet bowl and flushing it with water (disposable), making it hygienic.

### <<First Fold Line 111 and First Fold Piece 112>>

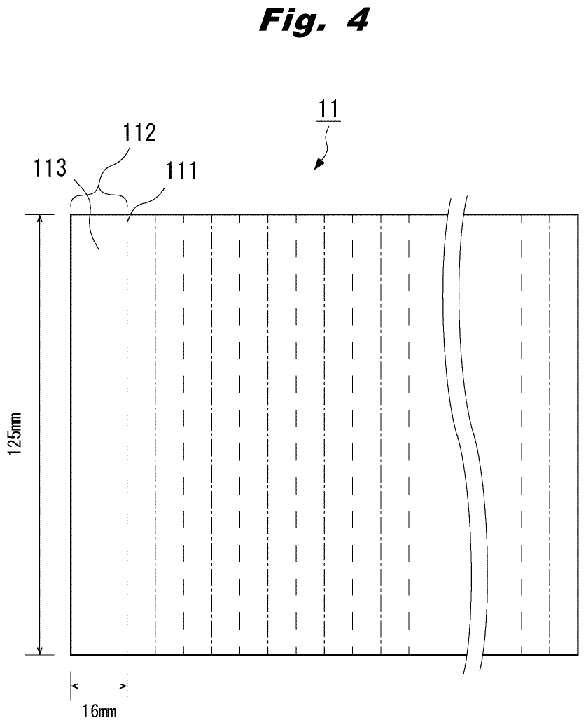

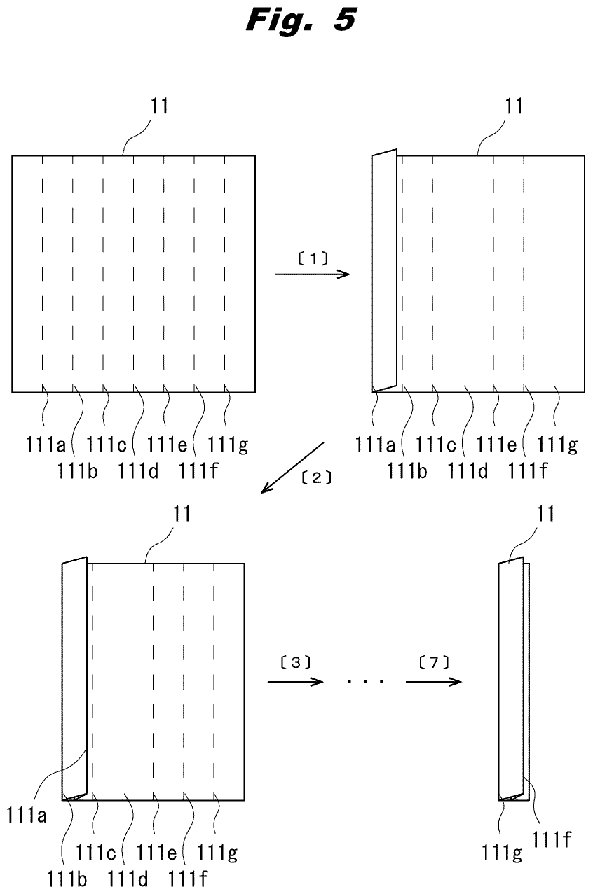

As shown in FIG. 4, sheet 11 has a plurality of first fold lines 111, which are fold lines, arranged at intervals of about 16 mm. In other words, the first fold pieces 112, which are fold pieces divided by the first fold lines 111, have a rectangular shape with a long side of about 125 mm and a short side of about 16 mm, and sheet 11 is configured with one more first fold piece 112 than the number of first fold lines 111. Sheet 11 is folded based on a plurality of first fold lines 111 (111a-111k in FIGS. 5 to 7) so that the plurality of first fold pieces 112 are stacked as shown in FIGS. 5 to 7 (the folding method is described below). As a result, sheet 11 becomes an abbreviated rectangular plate whose long side is parallel to first fold line 111.

The sizes of sheet 11 and first fold pieces 112 and the spacing (or interval) of first fold lines 111 etc. are not limited to those mentioned above. For example, as mentioned above, first fold line 111 is a fold line used as a standard for folding sheet 11 (helping the piece to be fold easily), but depending on the folding method, it is not possible to distribute them at equal intervals due to the thickness of sheet 11. In such cases, it is preferable to take the thickness of the sheet 11 into account and change the spacing between each of the first fold lines 111.

### <<Second Fold Line 113>>

Sheet 11 has second fold lines 113, which are fold lines used as a reference for folding toilet bowl cleaning tool 1 into an abbreviated L-shaped in the cross section. Second fold lines 113 are provided parallel to the long side and dividing the short side into halves after sheet 11 is folded based on the plurality of first fold lines 111 so that sheet 11 becomes an abbreviated rectangular shape. In other words, second fold lines 113 are, as shown in FIG. 4, placed one at the center of each pair of first fold pieces 112 when sheet 11 is unfolded.

### <Relationship Between Basis Weight of Sheet 11 and the Number of First Fold Piece 112>

Toilet bowl cleaning tool 1 can be configured by selecting a basis weight (or unit weight) of sheet 11 and the number of first fold pieces 112 as long as a product of the basis weight of sheet 11 and the number of first fold pieces 112 (hereinafter referred to as “evaluation index”) is ranged within 200 to 500 g/m². This allows toilet bowl cleaning tool 1 to be strong enough to remove the stains adhering to the inside of the toilet bowl, and to be entirely disposable.

The reasons for this are explained based on results of the following two experiments.

### <<Experiments on Strength of Toilet Bowl Cleaning Tool 1>>

The first experiment is an experiment pertaining to the strength of toilet bowl cleaning tool 1 (hereinafter referred to as the “strength experiment”).

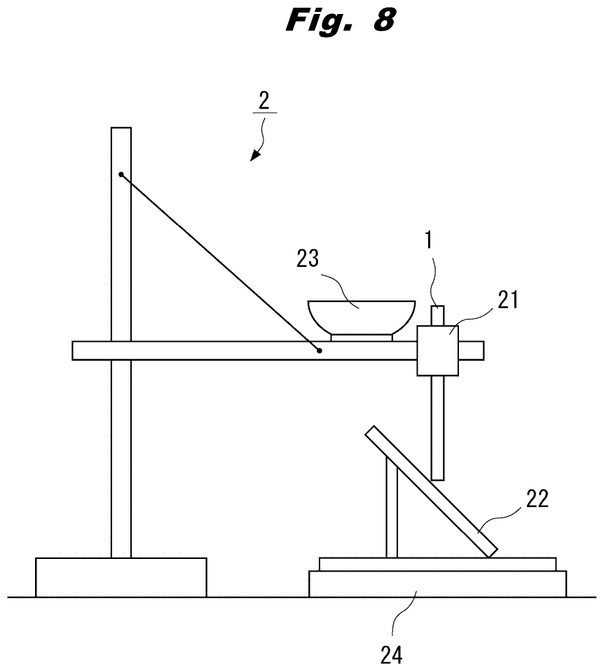

In the strength experiment, the load capacity [g] of toilet bowl cleaning tool 1 was measured using experimental apparatus 2 shown in FIG. 8, which consists of gripping part 21, contact plate 22, weight tray 23, and digital scale 24. Specifically, toilet bowl cleaning tool 1 and contact plate 22 were fixed to gripping part 21 so that they were in contact (at this timing, the display on digital scale 24 is set to zero). From this state, the load on toilet bowl cleaning tool 1 gradually increased by adding the weight placed on weight pan 23, and the indications on digital scale 24 were measured until the timing at which toilet bowl cleaning tool 1 broke. In the strength experiment, sheet 11 with basis weights of 40 g/m², 50 g/m², 60 g/m², 70 g/m², 80 g/m², and 90 g/m² were used, and the number of first fold pieces 112 varied. Contact plate 22 was used in the manner in which toilet bowl cleaning tool 1 was used (see FIGS. 3 and 4). Contact plate 22 was provided on digital scale 24 so that it was in contact with toilet bowl cleaning tool 1 at 45° angle, taking into account a manner in which toilet bowl cleaning tool 1 was actually used (see FIGS. 3 and 4).

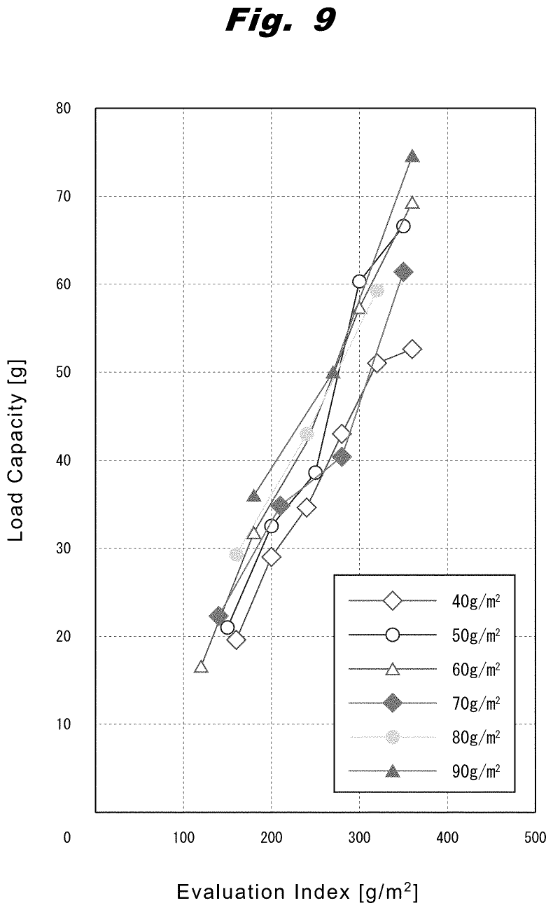

FIG. 9 summarizes the results of the strength experiment in a graph, which shows tha toilet bowl cleaning tool 1 has the characteristic that the load-bearing capacity increases as the evaluation index increases.

Further, actual use of each of toilet bowl cleaning tools 1 under the same conditions showed that toilet bowl cleaning tools 1 with load capacities of about 30 g or more (evaluation index of 200 g/m² or more) were able to maintain their strength until completely removing the stains adhering to the inside of the toilet bowl.

Based on the above, toilet bowl cleaning tool 1 of the present invention can have sufficient strength to remove the stain adhering to the inside of the toilet bowl when the evaluation index is 200 g/m² or more.

### <<Experiments on Water Solubility of Toilet Bowl Cleaning Tool 1>>

The second experiment was an experiment pertaining to the water solubility of toilet bowl cleaning tool 1 (hereinafter, referred to as the “water solubility experiment”).

In the water solubility experiment, a magnetic stirrer (a device that uses magnetic force to rotate a stirrer and agitate a liquid) was used to measure the time [seconds] it took for toilet bowl cleaning tool 1 to be dissolved in water. Specifically, a 300 ml beaker containing 300 ml of water (water temperature of 20±5° C.) was placed on the magnetic stirrer, and the rotor (a disk-shaped device with a diameter of 35 mm and a thickness of 12 mm) was adjusted so that the rotational speed of the rotor (35 mm in diameter and 12 mm thick) was at around 600±10 rpm. The measurement was started when toilet bowl cleaning tool 1, which had been cut so that its long side was approximately 50 mm. For convenience, the length of the tool was adjusted so that it fit into the beaker. The rotational speed of the rotor decreased to about 500 rpm due to the resistance caused by toilet bowl cleaning tool 1 being inserted, but as toilet bowl cleaning tool 1 dissolved in water, the resistance decreased, and the rotational speed increased. In the water solubility experiment, the time until the rotational speed of the rotor recovered to 540 rpm was measured. For convenience, it was assumed that toilet bowl cleaning tool 1 was completely solubilized when the rotational speed of the rotor recovered to 540 rpm. The time taken for the water solubility to recover to 540 rpm was measured. In the water solubility experiment, sheets 11 with basis weights of 40 g/m², 50 g/m², 60 g/m², 70 g/m², 80 g/m², and 90 g/m² were used, and the measurements were performed as the number of first fold pieces 112 varied.

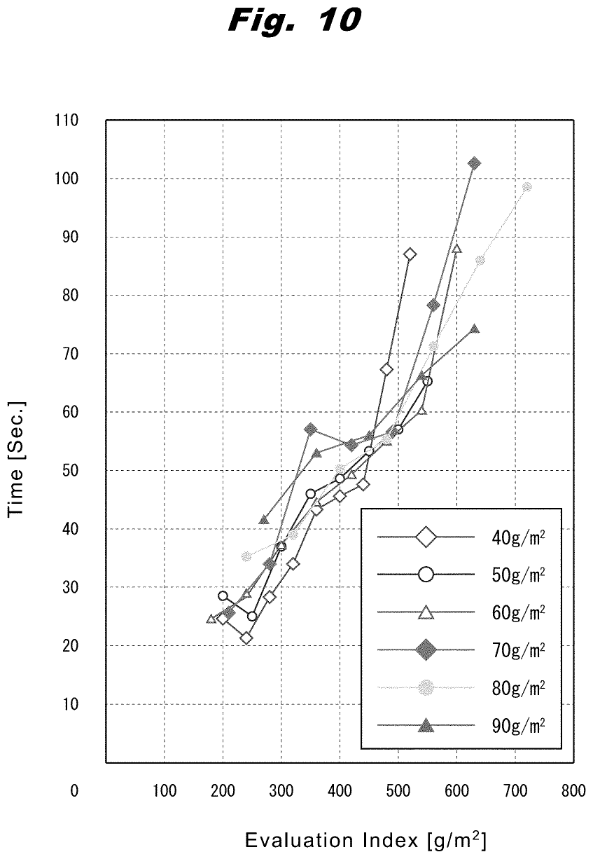

FIG. 10 summarizes the results of the water solubility experiment in a graph, which shows that toilet bowl cleaning tool 1 has the characteristic that the smaller the evaluation index is, the shorter the time to be dissolved becomes.

When toilet bowl cleaning tool 1 under the same conditions is disposed of by discarding it in the toilet bowl and flushing it with water, if toilet bowl cleaning tool 1 dissolves in water within 60 seconds (or the evaluation index of the sheet is 500 g/m² or less), toilet bowl cleaning tool 1 will not cause the toilet bowl to be clogged.

Based on the above, it became understood that entire toilet bowl cleaning tool 1 can be disposed/discarded in the toilet bowl when the evaluation index is 500 g/m² or less.

### [Manufacturing Method of Toilet Bowl Cleaning Tool 1]

Toilet bowl cleaning tool 1 of the present invention is manufactured easily by folding sheet 11 based on first fold line 111 and then folding it based on second fold line 113. Although there is no particular limitation on the way/method of folding sheet 11 based on first fold line 111, a typical way/method is described below.

<Folding Method 1: Fold from One End to the Other in their Order>

The first folding method (hereinafter referred to as “folding method 1”) is a method in which sheet 11 is folded based on first fold lines 111, starting from the edge of sheet 11 in the order. The edge is selected from one pair of the edges which is parallel to the first fold lines.

For example, as shown in FIG. 5, in a case where sheet 11 has seven first fold lines 111a-111g, the method has steps of folding sheet 11 seven times in the order of: [1] first fold line 111a, [2] first fold line 111b, [3] first fold line 111c, . . . , [7] first fold line 111g.

### <Folding Method 2: Reducing the Number of Folds>

The second folding method (hereinafter referred to as “folding method 2”) is a method in which sheet 11 is folded based on the first fold lines 111, preferentially from the center of sheet 11 toward the edge. This method can be used when sheet 11 has an even number of first fold pieces 112.

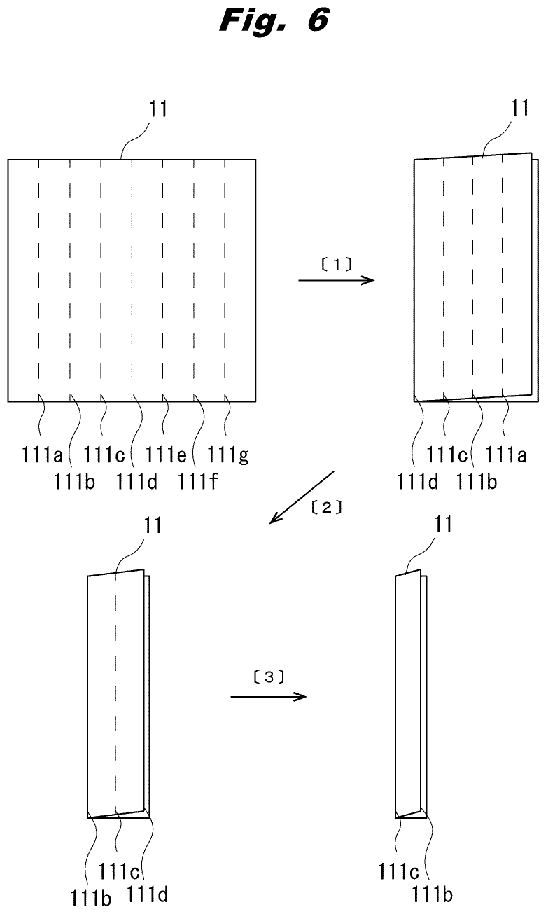

For example, as shown in FIG. 6, in a case where sheet 11 has eight first fold pieces 112 and seven first fold lines 111a-111g, the method has steps of folding sheet 11 three times in the order of: [1] first fold line 111d, [2] first fold line 111b (and first fold line 111f), [3] first fold line 111c (and first fold lines 111a, 111e, 111g).

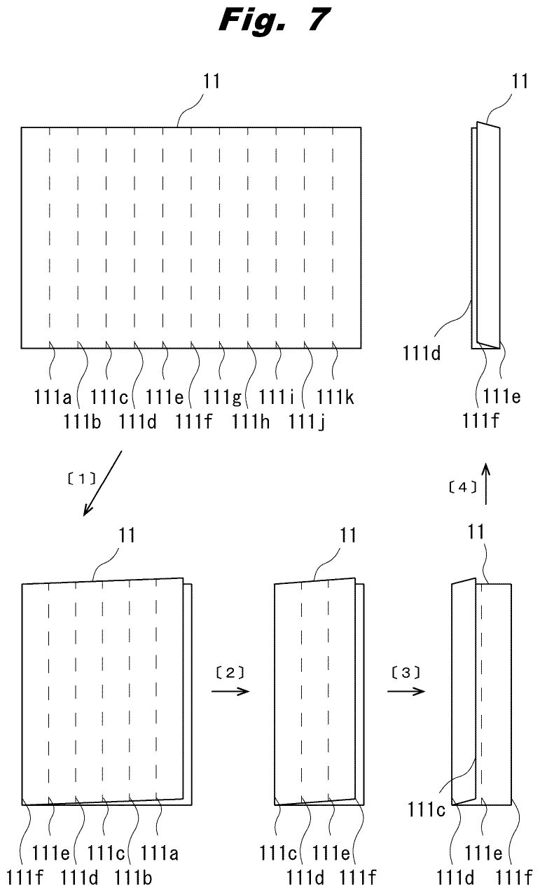

Further, for example, as shown in FIG. 7, when sheet 11 has twelve first fold pieces 112 and eleven first fold lines 111a to 111k, the method has steps of folding sheet 11 four times in the order of: [1] first fold line 111f, [2] first fold line 111c (and first fold line 111i), [3] first fold line 111d (and first fold lines 111b, 111h, 111j), and [4] first fold line 111e (and first fold lines 111a, 111g, 111k).

In other words, folding method 2 is a method in which multiple first fold lines 111 are folded simultaneously in the second and subsequent folding steps. This means that, whereas folding method 1 requires folding the sheet 11 as many times as the number of first fold lines 111, folding method 2 can reduce the number of folds and increase the production speed. The difference between folding method 2 in FIG. 6 and folding method 2 in FIG. 7 is that folding method 2 in FIG. 7 includes a part of folding method 1 and is combined with the folding method 1. The timing of this combination is not limited to the case of FIG. 7, for example, when the number of first fold pieces 112 is odd, folding method 1 may be applied once first, and then folding method 2 may be applied after the number of fold pieces becomes even.

### <Folding Method 3: Using a Folding Plate>

Third folding method (hereinafter referred to as “folding method 3”) is a method in which sheet 11 is folded into a three folded state (triple folded state), and then further folded into two folded state (a half state).

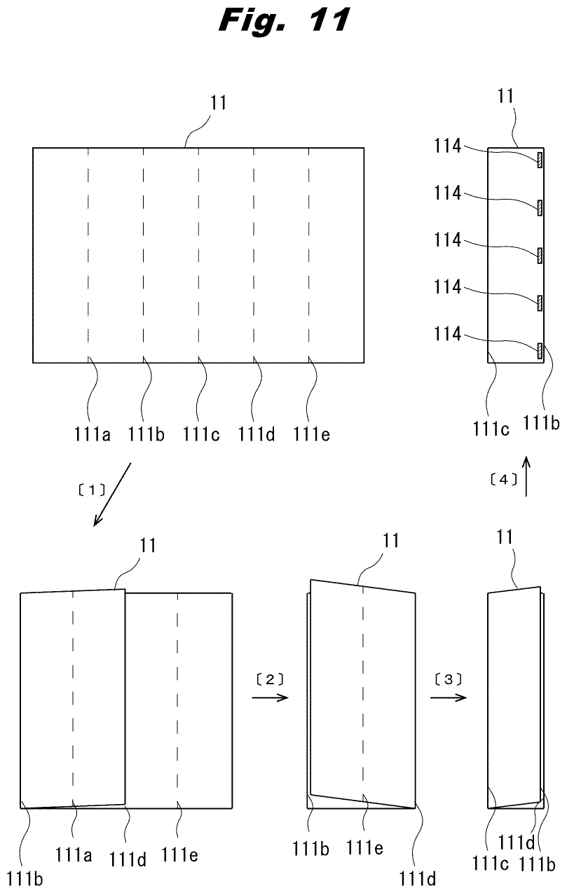

For example, as shown in FIG. 11, when sheet 11 has six first fold pieces 112 and five first fold lines 111a-111e, the method has steps of folding sheet 11 three times in the order: [1] first fold line 111b, [2] first fold line 111d, [3] first fold line 111e (and first fold line 111a). Then, as shown in FIG. 11 [4], the area near first fold line 111b is crimped/pinched. Crimped portion 114 is formed at the area that was crimped. Due to crimped portion 114, toilet bowl cleaning tool 1 is closed in a state where first fold line 111b and first fold line 111d are overlapping. Crimped portion 114 is not limited to toilet bowl cleaning tool 1 formed by folding method 3, but may be provided in toilet bowl cleaning tool 1 formed by folding method 1 or folding method 2.

In other words, folding method 3 is a method in which sheet 11 has as many first fold pieces 112 as the number of multiple(s) of three, is folded into a three folded state based on two of first fold lines 111, which are arranged at positions that divide sheet 11 into three equal parts, and after folding sheet 11 multiple times based on the plurality of first fold lines 111. Alternatively, folding method 3 is a method in which, after folding sheet 11 in the three folded state, sheet 11 is further folded into a two folded state. With folding method 3, when manufacturing, for example, toilet bowl cleaning tool 1 having six first fold pieces 112, by using a folding plate to fold sheet 11 so that it becomes a three folded state and then folded into a two folded state, such a tool can be manufactured, making the design of the manufacturing equipment easier and reducing the cost of the manufacturing equipment.

As explained above, by configuring toilet bowl cleaning tool 1 of the present invention to have the evaluation index of 200 to 500 g/m², the tool can be realized to be strong enough to remove a stain adhering to the inside of the toilet bowl and to be disposable as a whole. In addition, because it can be manufactured by folding a piece of sheet 11, it can be easily and inexpensively manufactured.

### LEGENDS

1 . . . Toilet bowl cleaning tool
11 . . . Sheet
111, 111a-111k . . . First fold line
112 . . . First 1
113 . . . Second fold line
114 . . . Crimped portion
2 . . . Experimental apparatus
21 . . . Gripping part
22 . . . Contact plate
23 . . . Weight tray
24 . . . Digital scale

What is claimed is:

1. A toilet bowl cleaning tool formed from a single sheet, which is rectangular and water soluble, for removing a stain from an inside of a toilet bowl, wherein
the sheet has
a plurality of first fold lines that are fold lines parallel to one of sides of the sheet and that divide the sheet at equal intervals,
a plurality of first fold pieces that are pieces segmented by the first fold lines, and
a second fold line that is a folding line used as a reference for folding the sheet into an approximately L-shape in a cross-section of the toilet bowl cleaning tool, wherein, after the sheet is folded based on the plurality of the first fold lines so that the first fold pieces are stacked to form an approximately rectangular shape whose longer sides are parallel to the first fold lines, the second fold line is provided to be parallel to the longer sides of the rectangular shape and to divide the shorter sides into an approximately half.

2. The toilet bowl cleaning tool according to claim 1, wherein
the first fold lines are used as a reference for folding the sheet in an order from one of the first fold lines that is positioned close to one of the vertical sides, which is parallel to the one of the first fold lines.

3. The toilet bowl cleaning tool according to claim 1, wherein
the sheet has a number of the first fold pieces that is two to the power of four or more,
the sheet is folded based on one of the first fold lines, which is positioned at a center of the sheet among the first fold lines, and is defined as a center fold line,
under a state where the sheet has been folded one or more times based on the first fold lines, the sheet is manufactured by being further folded based on the center fold line.

4. The toilet bowl cleaning tool according to claim 1, wherein
the sheet has a number of the first fold pieces that is an even number except for two to the power of any integer,
the sheet is folded based on one of the first fold lines, which is positioned at a center of the sheet among the first fold lines, and is defined as a center fold line,
under a state where the sheet has been folded one or more times based on the first fold lines, the sheet is further folded based on the center fold line, and
the first fold lines are used as a reference for folding the sheet in an order from one of the first fold lines that is positioned close to one of the sides of the sheet, which is parallel to the first fold lines.

5. The toilet bowl cleaning tool according to claim 1, wherein
a product of a basis weight of the sheet and the number of first fold pieces is ranged from 200 to 500 g/m².
